(19) United States
(12) Patent Application Publication
(10) Pub. No.: US 2017/0190239 A1
(43) Pub. Date: Jul. 6, 2017

(54) CONDENSER ARRANGEMENT FOR AN AIR CONDITIONING SYSTEM

(71) Applicant: Mahle International GmbH, Stuttgart (DE)

(72) Inventors: Joerg Schaper, Kornwestheim (DE); Hendrik Frank, Schwieberdingen (DE)

(21) Appl. No.: 15/314,078

(22) PCT Filed: May 27, 2015
(86) PCT No.: PCT/EP2015/061733

§ 371 Date: Nov. 26, 2016

(30) Foreign Application Priority Data
May 28, 2014 (DE) 10 2014 210 211.1

(51) Int. Cl. B60H 1/32; B60H 3/00; F28F 19/06

(52) U.S. Cl. CPC B60H 1/3227; F28F 19/06; B60H 3/0092

(57) ABSTRACT

A condenser arrangement for an air conditioning system may include at least one pipe wall composed of a metal, e.g., aluminium. A protective layer may be disposed on the at least one pipe wall. The protective layer may have a composition including 40 to 90 mass % zinc oxide (ZnO). The protective layer may additionally include a polymer binding agent and/or an additive.

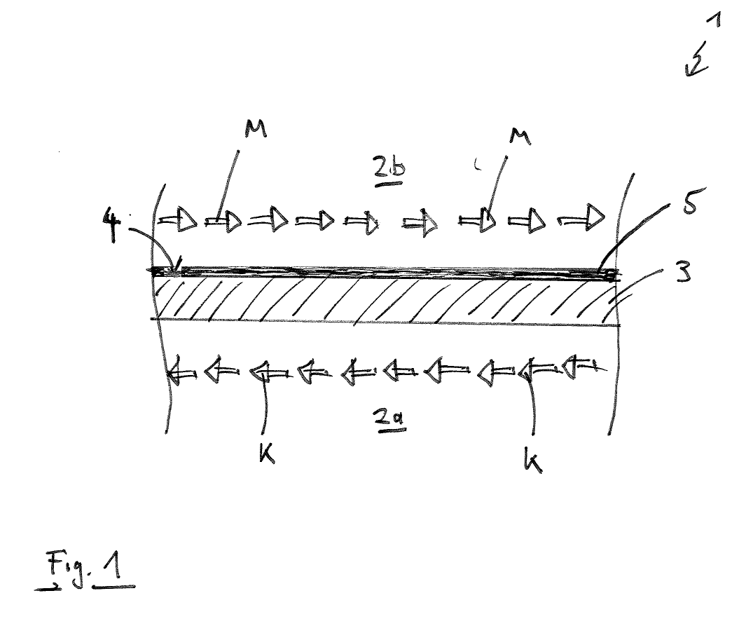

### CROSS-REFERENCE TO RELATED APPLICATIONS

This application claims priority to German Patent Application No. 10 2014 210 211.1, filed May 28, 2014, and International Patent Application No. PCT/EP2015/061733, filed May 27, 2015, both of which are hereby incorporated by reference in their entirety.

### TECHNICAL FIELD

The invention relates to a condenser arrangement for an air conditioning system and an air conditioning system with such a condenser arrangement. The invention further relates to a motor vehicle with such an air conditioning system.

### BACKGROUND

In air conditioning technology, a device in which a cooling agent, present in a compressed state, expands again and in so doing is converted into a gaseous aggregate state, is designated as a condenser. The energy required for the boiling of the cooling agent, the so-called evaporation enthalpy, is extracted in the condenser from the medium which is to be cooled, in an air conditioning system of a motor vehicle therefore for instance the air present in the vehicle interior, wherein said air cools down intensively. This mostly results in a condensation of water vapour contained in the air, typically on the pipe walls, made of metal, forming the condenser. This can lead to an undesired corrosion of the pipe walls. Furthermore, the condensate accumulating on the pipe walls often results in the formation of microorganisms on the pipe surface, whereby unpleasant odours can arise, which can be transported by the air, which is to be cooled, from the condenser into the vehicle interior.

Countermeasures known from the prior art therefore comprise the application of a protective coating onto the surface of the condenser pipe walls.

Thus, for instance, DE 100 45 606 A1 follows the approach of providing a metallic substrate, which can be part of a vehicle air conditioning system, with an oligodynamic surface coating. This comprises a matrix on the basis of polysiloxanes and heavy metal particles embedded into the matrix. A corrosion inhibitor serves here for corrosion protection.

DE 10 2005 027 934 A1 discloses a hydrophilic anti-microbial coating composition for an air conditioning system condenser with a hydrophilic organic polymer, a smoothing agent, an anti-microbial agent and deionized water.

DE 601 32 514 T2, finally, describes a method for producing a hydrophilic heat exchanger, in which for hydrophilization silicate particles and polymers of vinyl alcohol groups in an aqueous medium are used.

It proves to be a problem in the previously described measures that the typically only very small biocide quantity in conventional protective coatings entails a chronologically limited anti-microbial effect of the biocides, because these are mostly already washed out after a relatively short time period by the water vapour which has condensed to water on the pipe walls of the condenser.

### SUMMARY

It is therefore an object of the invention to create an improved embodiment of a condenser for an air conditioning system, in which the named disadvantages are largely or even completely eliminated.

This problem is solved by the subject of the independent claim(s). Preferred embodiments are the subject of the dependent claims.

The basic idea of the invention is, accordingly, to equip a metallic pipe wall of a condenser with a protective coating which is formed at 40 to 90 mass % from zinc oxide (ZnO) molecules. The zinc oxide that is introduced into the protective layer serves in the region of the layer surface as a so-called “sacrificial layer”, if aggressive substances present in the air stream, such as e.g. organic or inorganic acids—in particular formic acid, acetic acid, nitric acid, and sulphurous acid come into consideration—are deposited on the pipe wall of the condenser. Said zinc ions react with the acid components, whereby these can be neutralized.

The primary effect of the zinc oxide which is essential to the invention consists, however, in that on contact with condensed water vapour an anti-microbial or bacteriostatic effect is provided. As the zinc oxide, acting as biocide, is only water-soluble to a small extent, the formation of microorganisms on the pipe walls of the condenser, which are coated in such a manner, can be prevented over a considerably extended period of time compared to conventional condensers. The desired solubility of the zinc oxide can be adjusted here via the composition of the further components—in addition to zinc oxide—that are present in the protective layer.

A condenser arrangement according to the invention for an air conditioning system comprises at least one pipe wall made of a metal, in particular of aluminium. The pipe wall is provided with a protective layer which contains 40-90 mass % zinc oxide. Of course, not only one but several pipe walls of the condenser arrangement can be equipped with such a protective layer, for instance when the condenser arrangement is realized as a plate heat exchanger with a plurality of fluid ducts. Particularly good results as regards to the resistance with respect to the formation of microorganisms in the condenser are achieved when all relevant pipe walls are equipped with such a protective layer.

The anti-bacterial effect of zinc oxide can be intensified to a not insignificant extent in a preferred embodiment, in which the zinc oxide present in the protective layer is doped with magnesium ions or with copper ions.

The same effect can be achieved when—alternatively or additionally to the said magnesium—or copper ions—an organic zinc compound, in particular zinc pyrithione, was introduced into the zinc oxide.

In an advantageous further development, a polymer binding agent can be provided as further essential component in the protective layer—in addition to the already discussed zinc oxide —, which binding agent can form a proportion of 10 to 50 mass % of the protective layer. The hydrophilic properties of the protective layer, resulting for instance with a polymer binding agent through the zinc oxide filler, makes provision that the precipitated water does not deposit itself in drop form on the pipe walls and flow off therefrom, but rather that a thin a homogeneous liquid film forms. As a result, the condensed water can be discharged particularly quickly from the pipe wall surface, so that distinctly less water is deposited on the pipe walls than in conventional condensers. This results in an improved corrosion protection. At the same time, the constantly flowing water film cleans the pipe walls of the condenser and therefore counteracts the formation of microorganisms.

In an advantageous further development of the invention, the protective layer can comprise up to 10 mass % of at least one additive. For instance, a wetting agent, a pigment, a dye or a suitable inhibitor for the prevention of corrosion may come into consideration for this.

In a further alternative embodiment, the protective layer can comprise an organic-inorganic hybrid layer. The term “hybrid layer” is generally understood to mean here all those layers in which the layer-forming network has both organic and also inorganic components. This explicitly also includes both composite networks and also interpenetrating networks. By way of example, for instance mixtures of inorganic sol-gel systems with organic layer-forming systems are mentioned.

In another preferred embodiment, the protective layer can comprise a sol-gel layer. The term “sol-gel layer” includes here all inorganic or hybrid polymer layer systems produced by means of a sol-gel process known to the specialist in the art. For the production of a sol-gel layer, the sols used as coating solutions are firstly applied onto the substrate surface. During the entire coating process and the drying of the sol, the hydrolysis- and condensation reactions of the precursor molecules which are used lead, as a result, to a solid layer being formed from the sol particles via a gel-like intermediate state.

Particularly good results can be achieved as regards avoiding the formation of undesired microorganisms on the pipe walls if the protective layer is provided with a layer thickness of 0.5 μm to 20 μm. Furthermore, through such a configuration of the protective layer with a small layer thickness, it can be ensured that the gill-like openings typically present in the condenser are not closed in an undesirable manner by the protective layer.

It proves to be particularly advantageous if the protective layer contains zinc oxide with a particle size which is less than 10 μm. Up to this size the zinc oxide particles are particularly readily soluble.

Particularly expediently, the protective layer can be applied onto the pipe wall by a dipping method. However, the layer can also be produced by means of a plasma method, in particular at atmospheric pressure, wherein the zinc oxide evaporates and is deposited on the surface of the pipe wall. Here, co-evaporating organic, especially Si-organic or inorganic precursors, can be admixed.

The invention further relates to an air conditioning system with a compressor and with a condenser arrangement, cooperating with the compressor, said condenser arrangement having one or more of the previously mentioned features. The invention further relates to a motor vehicle with such an air conditioning system.

Further important features and advantages of the invention will emerge from the subclaims, from the drawings and from the associated FIGURE description with the aid of the drawings.

It shall be understood that the features mentioned above and to be explained further below are able to be used not only in the respectively indicated combination, but also in other combinations or in isolation, without departing from the scope of the present invention.

### BRIEF DESCRIPTION OF THE DRAWINGS

Preferred example embodiments of the invention are illustrated in the drawings and are explained further in the following description. The drawings show as follows:

The FIGURE illustrates a diagrammatic view of a condenser arrangement according to an example.

### DETAILED DESCRIPTION OF THE DRAWINGS

The single FIGURE illustrates in a rough diagrammatic illustration an example of a condenser arrangement 1 according to the invention, for an air conditioning system. A pipe wall 3 of a metal such as e.g. aluminium serves as a dividing wall between two fluid ducts 2a, 2b, wherein the first fluid duct 2a is flowed through by a cooling agent K and the second fluid duct 2b is flowed through by the medium M which is to be cooled, typically air. Through thermal interaction between cooling agent K and medium M which is to be cooled through the pipe wall 3, heat is extracted from the medium M and is delivered to the cooling agent K, wherein the liquid coolant K can evaporate. Water vapour contained in the medium M can condense during this process and can be precipitated to water on the side 4 of the pipe wall 3 facing the second fluid duct 2b. Therefore, on this side 4 of the pipe wall 3 a protective layer 5 is applied for the simultaneous protection from corrosion, for prevention of the colonisation of microorganisms and for hyrophilization, which for example can have a layer thickness of 0.5 μm to 20 μm. The protective layer 5 can be applied by means of a plasma- or dipping method onto the side 4 of the pipe wall 3 facing the medium M which is to be cooled, therefore typically air.

The protective layer 5 has zinc oxide (ZnO) as central component, which forms 40-90 mass % of the protective layer 5. A further 10 to 50 mass % can be formed by a polymer binding agent—thus, for example, polyurethane, polyvinyl alcohol, polyacrylate, polyepoxy —, which may serve for the sealing of the pipe wall 3. The hydrophilicity of the protective layer resulting through the combination of the polymer binding agent with the filler zinc oxide makes provision that the water precipitating through condensation does not deposit itself in drop form on the pipe walls, but rather a thin and homogenous liquid film forms. Therefore, the condensed water can be discharged particularly quickly from the pipe wall surface.

The antibacterial effect of the protective layer can be further intensified in a variant of the example, in which the zinc oxide present in the protective coating is doped with magnesium ions and/or copper ions. In order to achieve the same effect or to intensify this again, alternatively or respectively also an organic zinc compound, such as for example zinc pyrithione, can be additionally introduced into the zinc oxide.

Finally, also up to 10 mass % of further additives can be provided in the protective layer 5. Such an additive may be, for instance, a further suitable biocide. However, a wetting agent, a pigment, a dye or a suitable inhibitor for the prevention of corrosion also come into consideration.

In a variant of the example, the protective layer can also be configured as an organic-inorganic hybrid layer. The term “hybrid layer” includes here all those layers in which the layer-forming network has both organic and also inorganic components. Composite networks and interpenetrating networks are also explicitly included.

In a further variant, the protective coating can comprise a sol-gel layer, which was produced by means of a so-called sol-gel process and comprises inorganic or hybrid polymer layer systems. For the production of the sol-gel layer, the sols used as coating solutions are firstly applied onto the substrate surface. During the entire coating process and the drying of the sol, the hydrolysis- and condensation reactions of the precursor molecules which are used then lead to the desired solid layer being formed from the sol particles via a gel-like intermediate state.

1. A condenser arrangement for an air conditioning system, comprising:
at least one pipe wall composed of a metal; and
a protective layer disposed on the at least one pipe wall, wherein the protective layer has a composition including 40-90 mass % zinc oxide.

2. The condenser arrangement according to claim 1, wherein the zinc oxide is doped with at least one of magnesium ions and copper ions.

3. The condenser arrangement according to claim 1, wherein the zinc oxide includes an organic zinc compound.

4. The condenser arrangement according to claim 1, wherein the composition of the protective layer further includes 10 to 50 mass % of a polymer binding agent for surface sealing.

5. The condenser arrangement according to claim 1, wherein the composition of the protective layer further includes up to 10 mass % of at least one additive.

6. The condenser arrangement according to claim 1, wherein the protective layer is configured as an organic-inorganic hybrid layer.

7. The condenser arrangement according to claim 1, wherein the protective layer includes a sol-gel layer.

8. The condenser arrangement according to claim 1, wherein the protective layer has a layer thickness of 0.5 μm to 20 μm.

9. The condenser arrangement according to claim 1, wherein the zinc oxide of the protective layer has a particle size of <10 μm.

10. The condenser arrangement according to claim 1, wherein the protective layer is disposed onto the at least one pipe wall via at least one of a dipping technique and a plasma technique.

11. An air conditioning system for a motor vehicle, comprising:
a compressor; and
a condenser arrangement cooperating with the compressor, the condenser arrangement including:
at least one pipe wall composed of an aluminium material; and
a protective layer disposed on the at least one pipe wall, the protective layer composed of a material including 40-90 mass % of zinc oxide, wherein the zinc oxide includes an organic zinc compound.

12. A motor vehicle, comprising:
an air conditioning system including a compressor and a condenser arrangement cooperating with the compressor, wherein the condenser arrangement includes:
at least one pipe wall composed of an aluminium material; and
a protective layer disposed on the at least one pipe wall, the protective layer composed of a material including 40-90 mass % of zinc oxide and 10 to 50 mass % of a polymer binding agent to facilitate surface sealing, wherein the zinc oxide includes at least one of zinc oxide doped with magnesium ions and zinc oxide doped with copper ions.

13. The motor vehicle according to claim 12, wherein the zinc oxide further includes zinc pyrithione.

14. The motor vehicle according to claim 12, wherein the material of the protective layer further includes up to 10 mass % of at least one additive.

15. The air conditioning system according to claim 11, wherein the material of the protective layer further includes 10 to 50 mass % of a polymer binding agent to facilitate surface sealing.

16. The air conditioning system according to claim 15, wherein the polymer binding agent includes at least one of polyurethane, polyvinyl alcohol, polyacrylate and polyepoxy.

17. The air conditioning system according to claim 11, wherein the organic zinc compound includes zinc pyrithione.

18. The air conditioning system according to claim 11, wherein the zinc oxide further includes at least one of zinc oxide doped with a magnesium ion and zinc oxide doped with a copper ion.

19. The condenser arrangement according to claim 1, wherein the metal includes aluminium.

20. The condenser arrangement according to claim 3, wherein the organic zinc compound includes zinc pyrithione.
